(19) United States
(12) Patent Application Publication
(10) Pub. No.: US 2019/0054770 A1
(43) Pub. Date: Feb. 21, 2019

(54) OFF THE ROAD TIRE

(71) Applicant: The Goodyear Tire & Rubber Company, Akron, OH (US)

(72) Inventors: John David WILSON, Clinton, OH (US); Max Harold DIXON, Kent, OH (US); Steven LEWKOWICZ, South Euclid, OH (US); Todd Andrew BACHOCHIN, Peninsula, OH (US)

(21) Appl. No.: 15/678,136

(22) Filed: Aug. 16, 2017

(51) Int. Cl. B60C 11/03

(52) U.S. Cl. CPC B60C 11/0311; B60C 11/0304; B60C 2011/0353; B60C 2200/14; B60C 2011/0313; B60C 2011/0388

(57) ABSTRACT

A tread for a tire includes a plurality of circumferential rows extending around a radially outer portion of the tire. Each row defines a plurality of tread lugs. Each tread lug has a radially outer surface. The radially outer surfaces have an asymmetric curvature such that a radially outermost point on each surface is not located on an axis of symmetry of each tread lug.

### FIELD OF THE INVENTION

The present invention relates to off the road tires, and more particularly, to a tread for an off the road tire.

### BACKGROUND OF THE INVENTION

A structure has been disclosed where a band-like rib is formed in the center of an outside periphery of a tire and where lugs are connected thereto and on both sides thereof diagonally with respect to a tire width direction. Meanwhile, the performance heretofore required for off the road tires, such as tractors and/or agricultural applications, has included traction performance in fields and low compaction performance for not damaging those fields. However, in recent years, efforts have been made to increase the speed at which these tires may travel on public/paved roads. This has led to heretofore unencountered challenges as these tires may perform and wear in unforeseen ways. For example, greater amounts of vibration at higher speeds may not be acceptable.

One conventional tire may include lug blocks that are disposed in a tread portion and are formed alternately on both sides of a tire equatorial plane in a tire circumferential direction and a central rib that extends in the tire circumferential direction at a tire width direction central portion of the tread portion and to which end portions of the lug blocks on the tire equatorial plane side are integrally connected. The lug blocks and the central rib may be integrally interconnected in the tread portion, and land portions may be continuously disposed. As compared to a tire with independent lug blocks and many edges in the central portion of the tread, the conventional tire may have fewer edges and fewer variations in tread gauge between the lug blocks accompanying heat shrinkage after vulcanization. Tire vibration during high-speed travel on paved roads may thereby be significantly reduced. In this way, the conventional tire may reduce vibration during high-speed travel on paved roads without lowering traction performance in fields.

### SUMMARY OF THE INVENTION

A tread for a tire in accordance with the present invention includes a plurality of circumferential rows extending around a radially outer portion of the tire. Each row defines a plurality of tread lugs. Each tread lug has a radially outer surface. The radially outer surfaces have an asymmetric curvature such that a radially outermost point on each surface is not located on an axis of symmetry of each tread lug.

According to another aspect of the tread, the asymmetric curvature is defined by a non-constant radius of curvature.

According to still another aspect of the tread, each tread lug has inclined planar sidewalls defining a radial height of the tread lug and each sidewall is inclined at a different angle than an opposite sidewall of the tread lug.

According to yet another aspect of the tread, the plurality of circumferential rows includes a center row symmetric about a centerplane of the tread.

According to still another aspect of the tread, the plurality of circumferential rows includes a shoulder row having tread lugs separated by lateral grooves.

According to yet another aspect of the tread, the plurality of circumferential rows includes a first row of lugs extending from a lateral tread edge of the tread axially inward to a row of first sipes.

According to still another aspect of the tread, the plurality of circumferential rows includes adjacent the first sipes, a second row of lugs axially located between the first row of lugs, a third row of lugs, and a fourth row of lugs.

According to yet another aspect of the tread, a shape of the lugs of the second row of lugs is defined by the first sipes, a first row of lateral grooves, a row of second sipes, a row of third sipes, and a second row of lateral grooves.

According to still another aspect of the tread, the row of second sipes is inclined alternately with equal, but opposite angles.

According to yet another aspect of the tread, the row of third sipes is disposed coincidently on a centerplane of the tread.

A tire in accordance with the present invention includes a tread with a plurality of circumferential rows extending around a radially outer portion of the tire, each row defining a plurality of tread lugs, one of the tread lugs of one of the rows having a radially outer surface, the radially outer surface having an asymmetric curvature such that a radially outermost point on the surface is not located on an axis of symmetry of the tread lug.

According to another aspect of the tire, the asymmetric curvature is defined by a non-constant radius of curvature.

According to still another aspect of the tire, the tread lug has inclined planar sidewalls defining a radial height of the tread lug, one sidewall being inclined at a different angle than another opposite sidewall.

According to yet another aspect of the tire, the plurality of circumferential rows includes a center row symmetric about a centerplane of the tread.

According to still another aspect of the tire, the plurality of circumferential rows includes a shoulder row having tread lugs separated by lateral grooves.

According to yet another aspect of the tire, the plurality of circumferential rows includes a first row of lugs extending from a lateral tread edge of the tread axially inward to a row of first sipes.

According to still another aspect of the tire, the plurality of circumferential rows includes, adjacent the first sipes, a second row of lugs axially located between the first row of lugs, a third row of lugs, and a fourth row of lugs.

According to yet another aspect of the tire, a shape of the lugs of the second row of lugs is defined by the first sipes, a first row of lateral grooves, a row of second sipes, a row of third sipes, and a second row of lateral grooves.

According to still another aspect of the tire, the row of second sipes is inclined alternately with equal, but opposite angles.

According to yet another aspect of the tire, the row of third sipes is disposed coincidently on a centerplane of the tread.

### Definitions

The following definitions are controlling for the disclosed invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2% to 0.8% of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire) laterally from shoulder to shoulder edge, when mounted on the design rim and subjected to a specified load and when inflated to a specified inflation pressure for said load.

“Void Space” means areas of the tread surface comprising grooves, notches and sipes.

### BRIEF DESCRIPTION OF THE DRAWINGS

The present invention will be more clearly understood by the following description of some examples thereof, with reference to the accompanying drawings, in which:

FIG. 1 is a schematic orthogonal view of a tire for use with the present invention;

FIG. 2 is a schematic perspective detail view of part of a tread for use with the present invention; and

FIG. 3 is a schematic sectional view of a tread lug in accordance with the present invention.

### DESCRIPTION OF EXAMPLES OF THE PRESENT INVENTION

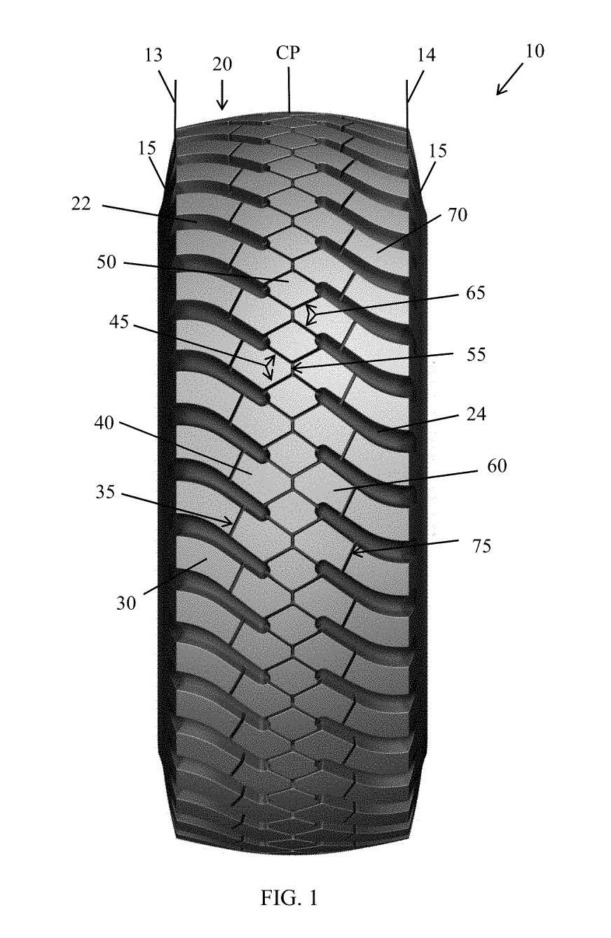

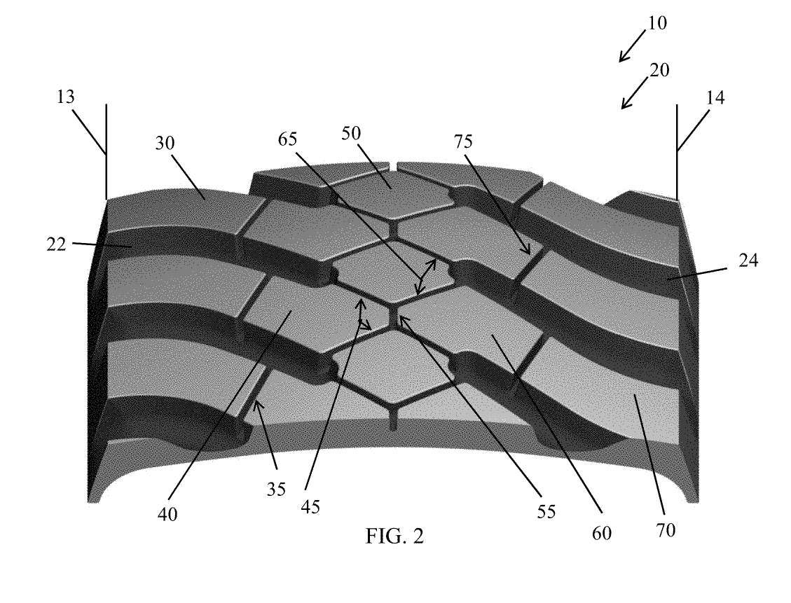

FIGS. 1-2 show an example pneumatic tire 10 for use with the present invention. The tire 10 may have an example nominal rim diameter of 35 inches or more. The tire 10 may have an outer ground engaging tread 12 which terminates in axially outer lateral edges 13, 14. Sidewall portions 15 may extend radially inward from the tread lateral edges 13, 14 and terminate in a pair of bead regions having an annular bead core (not shown). The tire 10 may further include other structures and components known to those skilled in the art.

The tread 12 may have a non-directional tread pattern. The tread 12 may include two rows of inclined shoulder grooves 22, 24. Each row of shoulder grooves 22, 24 may extend laterally and circumferentially from a respective lateral tread edge 13, 14 towards a centerplane CP of the tread 12. The shoulder grooves 22, 24 may not extend past the centerplane CP of the tread 12. The shoulder grooves 22 in the first row may be circumferentially offset or staggered from the shoulder grooves 24 in the second row. The shoulder grooves 22 in the first row may be similarly shaped as the shoulder grooves 24 in the second row and have an angular orientation at about 180 degrees opposite that the shoulder grooves 24 in the second row.

The tread 12 may be further divided into five rows of lugs. A first row of shoulder lugs 30 may extend from the lateral tread edge 13 axially inward to a row of first sipes 35. Adjacent the first sipes 35, a second intermediate row of lugs 40 may be axially located between the first row of lugs 30, a third center row of lugs 50, and a fourth intermediate row of lugs 60. The second intermediate row of lugs 40 may be bordered by the first sipes 35, one of the first row of lateral grooves 22, a row of second sipes 45, a row of third sipes 55, and another of the first row of lateral grooves 22. The row of second sipes 45 may be inclined alternately with equal, but opposite angles. The row of third sipes 55 may be disposed coincidently on the centerplane CP of the tire 10.

The third center row of lugs 50 may be axially located between the second intermediate row of lugs 40 and the fourth intermediate row of lugs 60. The third center row of lugs 50 may be disposed symmetrically about the centerplane CP and may be bordered by the seconds sipes 45, third sipes 55, and a row of fourth sipes 65. The row of fourth sipes 65 may be inclined alternately with equal, but opposite angles and these angles may each be opposite the angles of the circumferentially adjacent row of second sipes 45. As shown in FIG. 1, each lug 50 may thereby be defined by one of the first row of lateral grooves 22, one of the second row of lateral grooves 24, two adjacent and opposite second sipes 45, and two opposite and adjacent fourth sipes 65.

The fourth intermediate row of lugs 60 may be axially located between the second intermediate row of lugs 40, the third center row of lugs 50, and a fifth shoulder row of lugs 70. The fourth intermediate row of lugs 60 may be bordered by the third sipes 55, the fourth sipes 65, one of the second row of lateral grooves 24, a row of fifth sipes 75, and another one of the second row of lateral grooves 24. The row of fifth sipes 75 may be inclined at the same angle as the first sipes 35. As shown in FIG. 1, each lug 60 may thereby be defined by one of the second row of lateral grooves 24, another one of the second row of lateral grooves 24, two adjacent and opposite fourth sipes 65, and a fifth sipe 75. The fifth row of shoulder lugs 70 may extend from the lateral tread edge 14 axially inward to the fifth sipes 75.

The shoulder grooves may have a depth of between 70 percent to 100 percent of a non-skid tread depth, or NSK, of the tread 12. The shoulder grooves 22, 24 may be angled between about 30 degrees to 60 degrees or between about 40 degrees to 50 degrees relative the centerplane CP of the tire 10. These grooves 22, 24 may thereby provide forward, rearward, and lateral traction. The first sipes 35, second sipes 45, third sipes 55, fourth sipes 65, and fifth sipes 75 may have depths varying between from about 50 percent NSK to about 80 percent NSK.

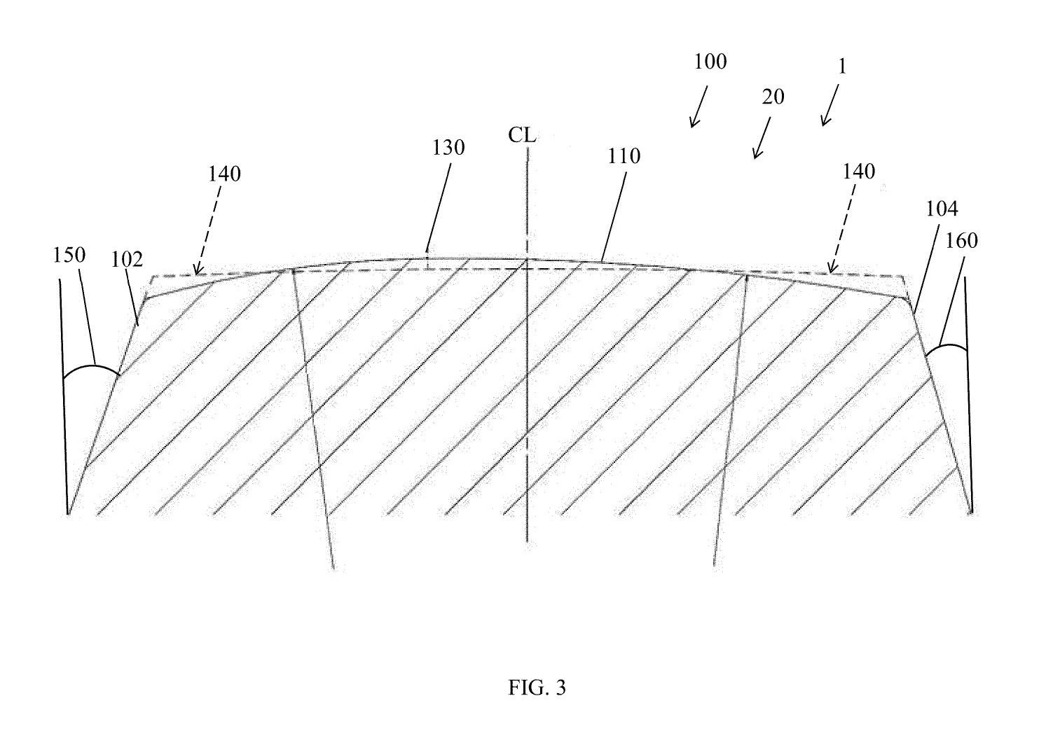

In accordance with the present invention, FIG. 3 shows a tread lug 100, which may be any tread lug including those 30, 40, 50, 60, 70 described above. The tread lug 100 includes non-planar contact surface 110 for engaging a terrain for the tire 1. The surface, or crown 110, of the tread lug 100 may not be symmetrical about a centerline CL of the tread lug, as viewed in FIG. 3. As a result, the radially outermost point 130, or tangency point, may not be located on the centerline CL in this view and/or any centerline of any other elevation view of the tread lug 100. The nonsymmetric curvature may thus have varying radii of curvature at different points on the surface 110. A conventional planar lug surface 140 is shown in phantom. In the view of FIG. 3, the radially outer most point 130 is a single point, not every point of the fully defined plane of the conventional surface 140. In order to compensate for this asymmetric curvature of the tread lug surface 110, opposite sidewalls 102, 104 of the tread lug 100 may have differing angles of inclination, 150, 160, respectively. The angle 150 may not equal the angle 160.

Such a tread lug surface 110 may relieve pressure at the edges of the tread lug 100 and relocate forces towards the radially thicker portions of the tread lug surface, such as the points on the tread lug surface 110 radially above the conventional planar lug surface 140.

Variations in the present invention are possible in light of the description of examples of it provided herein. While certain representative examples and details have been shown for the purpose of illustrating the subject invention, it will be apparent to those skilled in this art that various changes and modifications can be made therein without departing from the scope of the subject invention. It is, therefore, to be understood that changes can be made in the particular examples described which will be within the full scope of the present invention as defined by the following appended claims. Further, the present invention is not limited to the examples hereinbefore described which may be varied in both construction and detail within the full scope of the appended claims.

What is claimed:

1. A tread for a tire comprising a plurality of circumferential rows extending around a radially outer portion of the tire, each row defining a plurality of tread lugs, each tread lug having a radially outer surface, the radially outer surface having an asymmetric curvature such that a radially outermost point on each surface is not located on an axis of symmetry of each tread lug.

2. The tread as set forth in claim 1 wherein the asymmetric curvature is defined by a non-constant radius of curvature.

3. The tread as set forth in claim 1 wherein each tread lug has inclined planar sidewalls defining a radial height of the tread lug, each sidewall being inclined at a different angle than an opposite sidewall of the tread lug.

4. The tread as set forth in claim 1 wherein the plurality of circumferential rows includes a center row symmetric about a centerplane of the tread.

5. The tread as set forth in claim 1 wherein the plurality of circumferential rows includes a shoulder row having tread lugs separated by lateral grooves.

6. The tread as set forth in claim 1 wherein the plurality of circumferential rows includes a first row of lugs extending from a lateral tread edge of the tread axially inward to a row of first sipes.

7. The tread as set forth in claim 6 wherein the plurality of circumferential rows includes adjacent the first sipes, a second row of lugs axially located between the first row of lugs, a third row of lugs, and a fourth row of lugs.

8. The tread as set forth in claim 7 wherein a shape of the lugs of the second row of lugs is defined by the first sipes, a first row of lateral grooves, a row of second sipes, a row of third sipes, and a second row of lateral grooves.

9. The tread as set forth in claim 8 wherein the row of second sipes is inclined alternately with equal, but opposite angles.

10. The tread as set forth in claim 9 wherein the row of third sipes is disposed coincidently on a centerplane of the tread.

11. A tire with a tread comprising a plurality of circumferential rows extending around a radially outer portion of the tire, each row defining a plurality of tread lugs, one of the tread lugs of one of the rows having a radially outer surface, the radially outer surface having an asymmetric curvature such that a radially outermost point on the surface is not located on an axis of symmetry of the tread lug.

12. The tire as set forth in claim 11 wherein the asymmetric curvature is defined by a non-constant radius of curvature.

13. The tire as set forth in claim 11 wherein the tread lug has inclined planar sidewalls defining a radial height of the tread lug, one sidewall being inclined at a different angle than another opposite sidewall.

14. The tire as set forth in claim 11 wherein the plurality of circumferential rows includes a center row symmetric about a centerplane of the tread.

15. The tire as set forth in claim 11 wherein the plurality of circumferential rows includes a shoulder row having tread lugs separated by lateral grooves.

16. The tire as set forth in claim 11 wherein the plurality of circumferential rows includes a first row of lugs extending from a lateral tread edge of the tread axially inward to a row of first sipes.

17. The tire as set forth in claim 16 wherein the plurality of circumferential rows includes, adjacent the first sipes, a second row of lugs axially located between the first row of lugs, a third row of lugs, and a fourth row of lugs.

18. The tire as set forth in claim 17 wherein a shape of the lugs of the second row of lugs is defined by the first sipes, a first row of lateral grooves, a row of second sipes, a row of third sipes, and a second row of lateral grooves.

19. The tire as set forth in claim 18 wherein the row of second sipes is inclined alternately with equal, but opposite angles.

20. The tire as set forth in claim 19 wherein the row of third sipes is disposed coincidently on a centerplane of the tread.
